(19) United States
(12) Patent Application Publication
(10) Pub. No.: US 2023/0058437 A1
(43) Pub. Date: Feb. 23, 2023

(54) METHOD FOR HUMAN-COMPUTER INTERACTION, APPARATUS FOR HUMAN-COMPUTER INTERACTION, DEVICE, AND STORAGE MEDIUM

(71) Applicant: BEIJING BAIDU NETCOM SCIENCE AND TECHNOLOGY CO., LTD., Beijing (CN)

(72) Inventors: Zhen WU, Beijing (CN); Jiaxiang GE, Beijing (CN); Xiao WANG, Beijing (CN); Xianze SU, Beijing (CN); Bing LIU, Beijing (CN); Jiawei WANG, Beijing (CN); Dan WANG, Beijing (CN); Song YANG, Beijing (CM); Jinghao HAO, Beijing (CN); Yufang WU, Beijing (CN); Qin QU, Beijing (CN); Bingqi ZHANG, Beijing (CN); Xiaoyin FU, Beijing (CN); Siyuan WU, Beijing (CN); Chao LI, Beijing (CN); Cong GAO, Beijing (CN); Lei JIA, Beijing (CN)

(21) Appl. No.: 17/706,409

(22) Filed: Mar. 28, 2022

(30) Foreign Application Priority Data
Aug. 18, 2021 (CN) 202110948729.1

(51) Int. Cl. G10L 15/22; G10L 15/34; G10L 13/027; G06F 40/40

(52) U.S. Cl. CPC G10L 15/22; G10L 15/34; G10L 13/027; G06F 40/40; G10L 2015/223

(57) ABSTRACT

The present disclosure provides a method for a human-computer interaction, an apparatus for a human-computer interaction, a device, and a storage medium, and the present disclosure relates to the field of artificial intelligence, such as deep learning and voice. A specific implementation includes: acquiring a voice command; performing voice recognition on the voice command to determine a corresponding voice text; sending, in response to satisfying a preset information sending condition, the voice text to a cloud; receiving a resource for the voice command returned from the cloud; and responding to the voice command based on the resource.

### CROSS-REFERENCE TO RELATED APPLICATIONS

The present application claims the priority of Chinese Patent Application No. 202110948729.1, titled “METHOD FOR HUMAN-COMPUTER INTERACTION, APPARATUS FOR HUMAN-COMPUTER INTERACTION, DEVICE, AND STORAGE MEDIUM”, filed on Aug. 18, 2021, the content of which is incorporated herein by reference in its entirety.

### TECHNICAL FIELD

The present disclosure relates to the field of computer technology, specifically to the field of artificial intelligence such as deep learning and voice, and more specifically to a method for a human-computer interaction, an apparatus for a human-computer interaction, a device, and a storage medium.

### BACKGROUND

With rapid development of computer technology, voice recognition technology has gradually penetrated into people's lives. With smart voice interaction, feedback results may be obtained only by speaking based on the new generation of interaction mode based on voice inputs. The applications of smart voice interaction systems in homes, vehicles, robots, and mobile phones make people's life more convenient. Smart voice interaction systems are integrated in smart networking terminals, such that drivers may operate the smart networking terminals by voice, to execute actions, such as switching on/off navigators, multimedia, in-vehicle settings, or answering/making calls. These actions were previously required to be executed by manually touching corresponding buttons, but now can be implemented by voice. The continuous improvement of the voice interaction effect can further bring about better human-computer interaction experience to users.

### SUMMARY

The present disclosure provides a method for a human-computer interaction, a device, and a storage medium.

According to a first aspect, a method for a human-computer interaction is provided, and the method includes: acquiring a voice command; performing voice recognition on the voice command to determine a corresponding voice text; sending, in response to satisfying a preset information sending condition, the voice text to a cloud; receiving a resource for the voice command returned from the cloud; and responding to the voice command based on the resource.

According to a second aspect, an electronic device is provided, the device includes: at least one processor; and a memory communicatively connected to the at least one processor; where the memory stores instructions executable by the at least one processor, and the instructions, when executed by the at least one processor, cause the at least one processor to execute the method according to the first aspect.

According to a third aspect, a non-transitory computer readable storage medium storing computer instructions is provided, where the computer instructions cause a computer to execute the method according to the first aspect.

It should be understood that contents described in the SUMMARY are neither intended to identify key or important features of some embodiments of the present disclosure, nor intended to limit the scope of the present disclosure. Other features of some embodiments of the present disclosure will become readily understood in conjunction with the following description.

### BRIEF DESCRIPTION OF THE DRAWINGS

The accompanying drawings are used for better understanding of the present solution, and do not impose any limitation on the present disclosure. In the accompanying drawings:

FIG. 1 is a diagram of an example system architecture in which an embodiment of the present disclosure may be implemented.

FIG. 2 is a flowchart of a method for a human-computer interaction according to an embodiment of the present disclosure.

FIG. 3 is a schematic diagram of an application scenario of the method for a human-computer interaction according to some embodiments of the present disclosure.

FIG. 4 is a flowchart of the method for a human-computer interaction according to another embodiment of the present disclosure.

FIG. 5 is a schematic structural diagram of an apparatus for a human-computer interaction according to an embodiment of the present disclosure.

FIG. 6 is a block diagram of an electronic device configured to implement the method for a human-computer interaction of some embodiments of the present disclosure.

### DETAILED DESCRIPTION OF EMBODIMENTS

Example embodiments of the present disclosure are described below with reference to the accompanying drawings, where various details of the embodiments of the present disclosure are included to facilitate understanding and should be considered merely as examples. Therefore, those of ordinary skills in the art should realize that various alterations and modifications can be made to the embodiments described here without departing from the scope and spirit of the present disclosure. Similarly, for clearness and conciseness, descriptions of well-known functions and structures are omitted in the following description.

It should be noted that the embodiments in the present disclosure and the features in the embodiments may be combined with each other on a non-conflict basis. The present disclosure will be described in detail below with reference to the accompanying drawings and in combination with the embodiments.

The technology according to some embodiments of the present disclosure can improve the efficiency of voice interaction, thereby improving the user interaction experience.

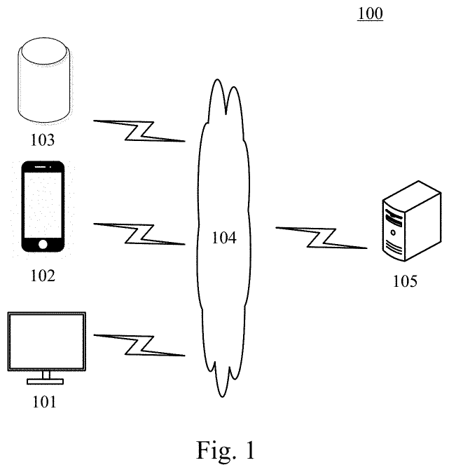

FIG. 1 is a diagram of an example system architecture in which an embodiment of the present disclosure may be implemented.

The system architecture 100 may include smart terminal devices 101, 102, and 103, a network 104, and a server 105. The network 104 serves as a medium providing a communication link between the smart terminal devices 101, 102, and 103, and the server 105. The network 104 may include various types of connections, such as wired or wireless communication links, or optical cables.

A user may interact with the server 105 using the smart terminal devices 101, 102, and 103 via the network 104, to receive or send information. The smart terminal devices 101, 102, and 103 may be provided with various communication client applications, such as a voice recognition application and a voice generation application. The smart terminal devices 101, 102, and 103 may alternatively be provided with an image collecting apparatus, a microphone array, a speaker, and the like.

The smart terminal devices 101, 102, and 103 may be hardware, or may be software. When the smart terminal devices 101, 102, and 103 are hardware, the smart terminal devices may be various electronic devices, including but not limited to a smart phone, a tablet computer, an e-book reader, a vehicle computer, a laptop portable computer, a desktop computer, and the like. When the smart terminal devices 101, 102, and 103 are software, the smart terminal devices may be installed in the above-listed electronic devices or may be implemented as a plurality of software programs or software modules (e.g., software programs or software modules for providing distributed services), or may be implemented as a single software program or software module. This is not specifically limited here.

The server 105 may be a server providing various services, such as a back-end server providing support for the smart terminal devices 101, 102, and 103. The back-end server may provide the smart terminal devices 101, 102, and 103 with a voice processing model, to obtain a processing result, and return the processing result to the smart terminal devices 101, 102, and 103.

It should be noted that the server 105 may be hardware or may be software. When the server 105 is hardware, the server may be implemented as a distributed server cluster composed of a plurality of servers or may be implemented as a single server. When the server 105 is software, the server may be implemented as a plurality of software programs or software modules (e.g., software programs or software modules for providing distributed services), or may be implemented as a single software program or software module. This is not specifically limited here.

It should be noted that the method for a human-computer interaction provided in embodiments of the present disclosure is generally executed by the smart terminal devices 101, 102, and 103. Accordingly, the apparatus for a human-computer interaction is generally provided in the smart terminal devices 101, 102, and 103.

It should be understood that the numbers of the smart terminal devices, the network, and the server in FIG. 1 are merely illustrative. Any number of smart terminal devices, networks, and servers may be provided based on actual requirements.

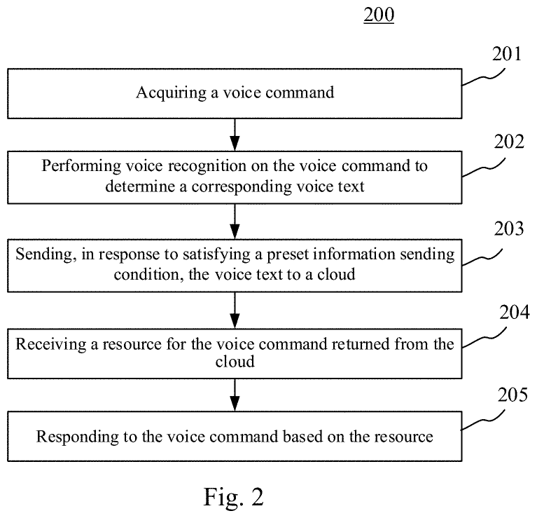

FIG. 2 is a flowchart of a method for a human-computer interaction according to an embodiment of the present disclosure. A process 200 of a method for a human-computer interaction according to an embodiment of the present disclosure is shown. The method for a human-computer interaction of the present embodiment includes the following steps:

Step 201: acquiring a voice command.

In the present embodiment, an executing body of the method for a human-computer interaction may acquire the voice command by various approaches, for example, may acquire the voice command by collecting a voice of a user through a communicatively connected microphone, or may acquire the voice command of the user through a social platform.

Step 202: performing voice recognition on the voice command to determine a corresponding voice text.

After acquiring the voice command, the executing body may perform the voice recognition on the voice command to determine the corresponding voice text. Here, the executing body may perform the voice recognition using a pre-trained neural network or an existing voice recognition algorithm. The voice recognition algorithm or the neural network may be integrated into a module, and the executing body may use the voice recognition algorithm or the neural network by invoking the module.

Step 203: sending, in response to satisfying a preset information sending condition, the voice text to a cloud.

The executing body may further detect whether the preset information sending condition is satisfied, and may send, if the preset information sending condition is satisfied, the voice text to the cloud. Here, the preset information sending condition may be a condition suitable for sending information, such as but not limited to a good network environment, a need for acquiring a resource from the network, an overlong voice text, and the like. Similarly, the executing body may further preset a condition that indicates not sending information, and if the condition that indicates not sending information is satisfied, the executing body may not send the voice text to the cloud. If the condition that indicates not sending information is not satisfied, the executing body may send the voice text to the cloud.

Step 204: receiving a resource for the voice command returned from the cloud.

In the present embodiment, after receiving the voice text, the cloud may acquire the resource for the voice command based on a corresponding business logic. The resource may be a document, a link, a text, and the like. The executing body may continuously send a resource acquisition request to the cloud within a preset duration to acquire the resource. If the cloud still fails to return the resource to the executing body over the preset duration, the executing body may return an error message to a terminal.

Step 205: responding to the voice command based on the resource.

After receiving the resource, the executing body may respond to the voice command. For example, if the resource includes a document, the executing body may control the terminal to display the document. When responding to the voice command, the executing body may first play a preset voice, such as “OK, I will check for you right away” or “Please wait a moment.”

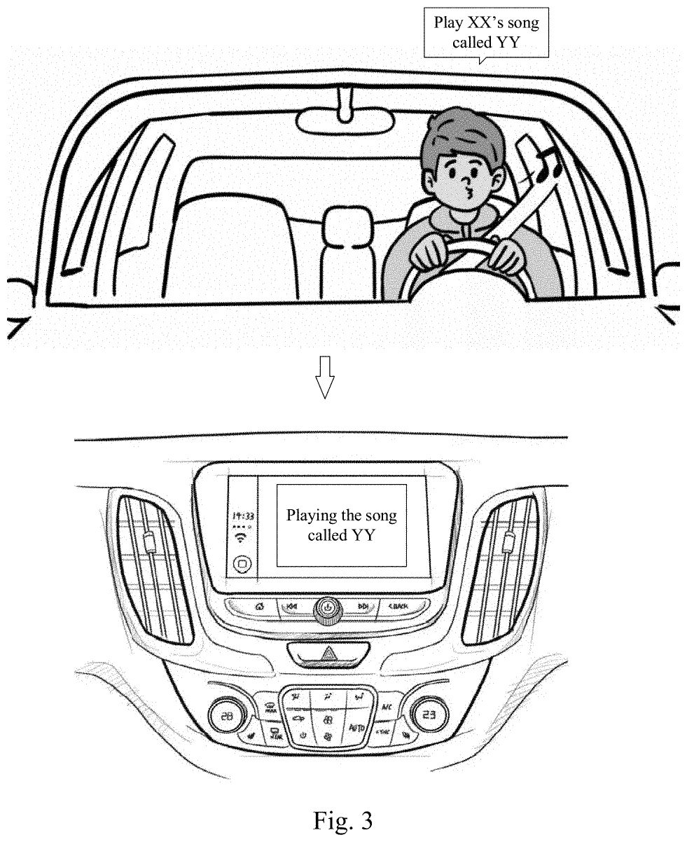

FIG. 3 is a schematic diagram of an application scenario of the method for a human-computer interaction according to some embodiments of the present disclosure. A schematic diagram of an application scenario of the method for a human-computer interaction according to some embodiments of the present disclosure is shown. In the application scenario of FIG. 3, a user performs voice interaction with an on-board terminal while driving a vehicle. The user says a voice command “play XX's song called YY.” The on-board terminal first performs voice recognition on the voice command to obtain a voice text of “play XX's song called YY.” Then, the on-board terminal determines that the song is not included in the local cache, determines that the preset information sending condition is satisfied, and sends the voice text to the cloud. After receiving the voice text, the cloud returns a link of the song to the on-board terminal, such that the on-board terminal acquires the song through the link and plays the song.

The method for a human-computer interaction provided in the above embodiments of the present disclosure can improve the efficiency of the voice interaction, thereby improving the user interaction experience, and at the same time the user privacy can be protected because of no need for uploading the voice to the cloud.

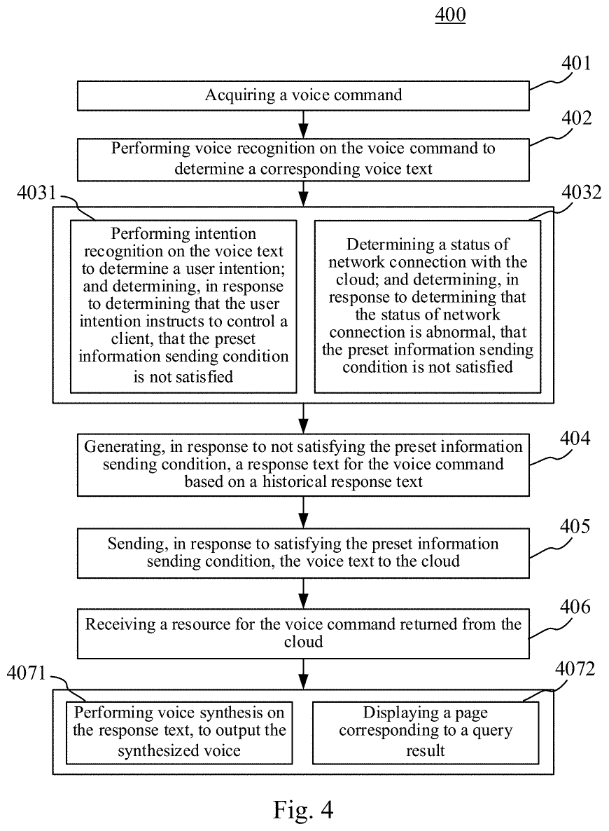

FIG. 4 is a flowchart of the method for a human-computer interaction according to another embodiment of the present disclosure. A process 400 of the method for a human-computer interaction according to another embodiment of the present disclosure is shown. As show in FIG. 4, the method of the present embodiment may include the following steps:

Step 401: acquiring a voice command.

In some alternative implementations of the present embodiment, after acquiring the voice command, an executing body may first perform acoustic echo cancellation (AEC) and voice activity detection (VAD) on the voice command, to improve the audio quality.

Step 402: performing voice recognition on the voice command to determine a corresponding voice text.

In the present embodiment, after determining the voice text, the executing body may determine whether the preset information sending condition is satisfied through steps 4031 and 4032.

Step 403: performing intention recognition on the voice text to determine a user intention; and determining, in response to determining that the user intention instructs to control a client, that the preset information sending condition is not satisfied.

In the present embodiment, the executing body may perform intention recognition on the voice text using an existing intention recognition algorithm to determine the user intention. If the user intention instructs to control the client, such as “turn on music” or “open a photo,” the executing body may determine that it is not necessary to send the command to cloud, and may determine that the preset information sending condition is not satisfied. Thus, it is not necessary to send a content that does not need cloud processing to the cloud, thereby reducing the network bandwidth occupancy, and at the same time avoiding a situation where the voice command cannot be processed at all when the network is unavailable or unstable.

In some alternative implementations of the present embodiment, before determining the voice text corresponding to the voice command, the executing body may alternatively first determine whether the voice command is a human-computer interaction command. Here, the human-computer interaction command refers to an interaction command between a person and a smart terminal device. The executing body may perform voice recognition on the voice command to determine the corresponding text if the voice command is a human-computer interaction command. The executing body may ignore the voice command if the voice command is not a human-computer interaction command.

In some alternative implementations of the present embodiment, the executing body may further determine whether the voice command belongs to a human-computer interaction command through the following steps that are not shown in FIG. 4: performing semantic analysis and intention recognition on the text information of the voice command to determine a user intention; determining a probability of the text information belonging to a sentence; determining a text length corresponding to the text information; determining acoustic confidence of a syllable corresponding to acoustic information of the voice command and acoustic confidence of an entire sentence corresponding to the acoustic information; and determining whether the voice command belongs to the human-computer interaction command based on at least one of the user intention, the probability, the text length, the acoustic confidence of the syllable, and the acoustic confidence of the entire sentence.

In the present implementation, the executing body may first analyze the voice command using various existing algorithms, for example, may first perform the semantic analysis and the intention recognition on the text information using an intention recognition algorithm to determine the user intention; or determine the probability that the text corresponding to the target voice command belongs to a sentence using a pre-trained language model. Here, the executing body may use the above text as an output of the language model, and the output of the language model may be a value for indicating the probability of the text belonging to the sentence. For example, a score of the language model of “How is the weather in Beijing” is higher than that of “Camping what box my person is people” and the score of the language model of the former is higher under the same sentence length. The higher the score of the text is, the higher the probability of the text belonging to a human-computer interaction command is.

The executing body may alternatively determine the length of the text in the text information. Generally, when a plurality of people speaks at the same time, the length of the recognized text will be too long, and the recognized text is a semantically meaningless text. In this case, the text is more probably not a human-computer interaction command.

The acoustic confidence of the syllable refers to a probability that each syllable of the outputted recognition result is correct from the acoustic perspective. For example, for a recognition result “pause,” if a user says “pause” to a real device, the syllable confidence will give scores such as “pau: 0.99, se: 0.98,” and the score of each syllable is very high. If a noise is recognized as “pause,” the syllable confidence will give scores such as “pau: 0.32, se: 0.23,” and the score of each syllable is low. The target audio command is more probably a human-computer interaction command, when the scores of most syllables are very high; or the command is not a human-computer interaction command, when the scores of most syllables are low. The executing body may determine the acoustic confidence of the syllable through a pre-trained syllable recurrent network. The syllable recurrent network is used for characterizing a corresponding relationship between a voice and acoustic confidence of a syllable.

The acoustic confidence of the entire sentence determines a probability that a current recognition result is correct from the acoustic perspective. The higher the score is, the higher the probability of a voice command being a human-computer interaction is, and vice versa.

The executing body may alternatively acquire a situation that a historical voice command belongs to a human-computer interaction command.

The executing body may map each piece of the above information to a value between [0,1]. During mapping, each piece of the above information may be coded, and then mapped based on the coding. Then, the executing body may uniformly input the obtained values into an input layer of a pre-trained network, to obtain a final outputted score (between 0 and 1) through hidden layer computation and finally through softmax computation. The higher the score is, the higher the probability of a voice command being a human-computer interaction command is. The above network may be, e.g., a DNN (deep neural network), or a LSTM (long short-term memory), or a transformer model (a model presented in a dissertation Attention is All You Need). The executing body may compare the score with a preset threshold, consider that the target voice command belongs to a human-computer interaction command if the score is greater than the preset threshold, and consider that the target voice command does not belong to a human-computer interaction command if the score is less than or equal to the preset threshold.

In some alternative implementations of the present embodiment, when the voice recognition is performed on the voice command, there may be a situation where a user voice is not accurately recognized. In this case, the executing body may determine the voice text through the following steps of: determining a definite text and an indefinite text in the voice command based on the acoustic confidence corresponding to the acoustic information and a preset confidence threshold; generating a prompt information based on the definite text and the indefinite text, and outputting the prompt information; receiving a response voice for the prompt information; recognizing a clarification text in the response voice; and determining a corresponding voice text based on the definite text and the clarification text.

In the present implementation, the executing body may compare the acoustic confidence corresponding to the acoustic information with a preset confidence threshold. The executing body may determine, if the acoustic confidence is greater than or equal to the confidence threshold, that a syllable can be accurately recognized, and the executing body may determine, if the acoustic confidence is less than the confidence threshold, that a syllable cannot be accurately recognized. The executing body may compose a word corresponding to the accurately recognized syllable into a definite text and may compose a word corresponding to the inaccurately recognized syllable into an indefinite text. The executing body may generate a prompt information based on the definite text and the indefinite text and output the prompt information. For example, the executing body obtains definite texts of “I'd like to listen to” and “a song,” and an indefinite text of “XXX” representing a singer name. Then, the executing body may determine that the prompt information is “Whose song would you like to listen to.” After outputting the prompt information, the executing body may receive the response voice of the user for the prompt information. After receiving the response voice, the executing body may recognize the clarification text in the response voice. For example, if the response voice is “Mr. A,” the clarification text is “Mr. A.” The executing body may determine the voice text based on the definite text and the clarification text. Specifically, the executing body may replace the indefinite text with the clarification text and combine the clarification text with the definite text to obtain the voice text.

Step 4032: determining a status of network connection with the cloud; and determining, in response to determining that the status of network connection is abnormal, that the preset information sending condition is satisfied.

In the present embodiment, the executing body may further detect the status of network connection with the cloud after determining the voice text, and the executing body may determine, if the status of network connection is poor or abnormal, that the preset information sending condition is not satisfied. Here, the poor status of network connection may mean that the network bandwidth is less than a preset threshold, and the abnormal status of network connection may mean that the network is unconnectable, or the network is intermittent.

Step 404: generating, in response to not satisfying the preset information sending condition, a response text for the voice command based on a historical response text.

In the present embodiment, if the preset information sending condition is not satisfied, the executing body does not need to send the voice text to the cloud, and thus cannot receive the resource from the cloud. In this case, the executing body may generate the response text for the voice command based on the historical response text. Here, the historical response text may be a response text received from the cloud for the historical voice command. The executing body may select a response text from historical response texts based on a similarity between a current voice command and the historical voice command, for use as a response text of the current voice command.

Step 405: sending, in response to satisfying a preset information sending condition, the voice text to cloud.

In some alternative implementations of the present embodiment, the executing body may further send the recognized text to the cloud in the process of voice recognition of the voice command when the preset information sending condition is satisfied.

Based on the present implementation, the executing body may recognize and send the text simultaneously, such that the cloud can quickly receive the recognized text, thereby improving the efficiency of information query.

In some alternative implementations of the present embodiment, the executing body may determine whether the recognized text satisfies a preset condition in the recognition process. The preset condition here may be that the number of words included in the recognized text is greater than a preset threshold, or the number of recognized texts hitting a historical voice text is greater than the preset threshold, or the like. Here, the hitting the historical voice text may mean that the recognized text belongs to a part of the historical voice text. For example, if the historical voice text is “How is the weather in Beijing,” and the recognized text is “the weather in Beijing,” it is determined that the recognized text hits the historical voice text. If the recognized text satisfies the preset condition, the executing body considers that the efficiency of information query or retrieval can be improved in this case, thereby sending the recognized text to the cloud. It should be appreciated that if the executing body sends every recognized word to the cloud immediately after the word is recognized, it not only increases the number of interactions between the cloud and the executing body, but also causes a low accuracy rate of the result retrieved or queried by the cloud when very fewer text information is recognized, thereby resulting in resource waste.

Step 406: receiving a resource for the voice command returned from the cloud.

In the present embodiment, sending the voice text to the cloud may be that the cloud uses a real-time updated network environment to acquire the resource or generate wording skills, thereby guaranteeing flexible adjustment and updating of the service logic.

Step 4071: performing voice synthesis on the response text, to output the synthesized voice.

In the present embodiment, if the resource returned from the cloud includes the response text, or the executing body itself generates the response text, voice synthesis may be further performed on the response text, to output the synthesized voice. The voice synthesis may be implemented using an existing voice synthesis algorithm. Then, the synthesized voice is outputted for playing.

Step 4072: displaying a page corresponding to a query result.

In the present embodiment, if the resource returned from the cloud includes the query result, the executing body may display the page corresponding to the query result. The query result may be a weather query result, a road condition query result, or the like. The page may be a card corresponding to the query result, such as, a card showing the weather. Alternatively, the executing body may further determine the dynamic effect of the corresponding page based on the query result. For example, if the query result of the weather is “fog,” the card may display a foggy effect.

In some alternative implementations of the present embodiment, if the executing body receives an intermediate resource sent from the cloud in the recognition process of the voice command, the intermediate resource may be displayed, such that the user can quickly see the intermediate resource, thereby improving the efficiency of a human-computer interaction, and improving the user experience.

The method for a human-computer interaction provided in the above embodiments of the present disclosure analyzes a voice command locally at a client, and sends a text to cloud only when a preset information sending condition is satisfied, such that the content of the uplink and downlink communication between the client and the cloud changes from an audio stream that needs to occupy a larger bandwidth to a text content that occupies a smaller bandwidth, thereby reducing the communication resource occupancy. Further, since the content of the uplink and downlink communication is smaller, the time consumption of the uplink and downlink communication is reduced, such that the user can receive the system response faster, thereby providing better user experience.

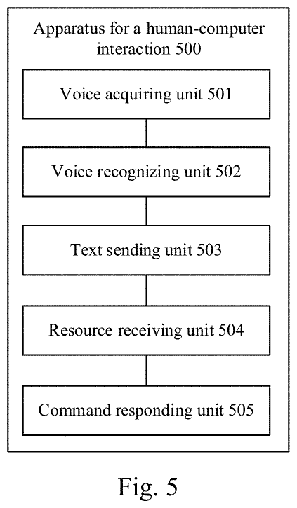

FIG. 5 is a schematic structural diagram of an apparatus for a human-computer interaction according to an embodiment of the present disclosure. An implementation of the method shown in the above figures, an embodiment of the present disclosure provides an apparatus for a human-computer interaction. The embodiment of the apparatus corresponds to the embodiment of the method shown in FIG. 2, and the apparatus may be specifically applied to various electronic devices.

As shown in FIG. 5, the apparatus 500 for a human-computer interaction of the present embodiment includes: a voice acquiring unit 501, a voice recognizing unit 502, a text sending unit 503, a resource receiving unit 504, and a command responding unit 505.

The voice acquiring unit 501 is configured to acquire a voice command.

The voice recognizing unit 502 is configured to perform voice recognition on the voice command to determine a corresponding voice text.

The text sending unit 503 is configured to send, in response to satisfying a preset information sending condition, the voice text to a cloud.

The resource receiving unit 504 is configured to receive a resource for the voice command returned from the cloud.

The command responding unit 505 is configured to respond to the voice command based on the resource.

In some alternative implementations of the present embodiment, the apparatus 500 may further include a first condition determining unit that is not shown in FIG. 5 and is configured to perform intention recognition on the voice text to determine a user intention; and determine, in response to determining that the user intention instructs to control a client, that the preset information sending condition is not satisfied.

In some alternative implementations of the present embodiment, the apparatus 500 may further include a second condition determining unit that is not shown in FIG. 5, and is configured to: determine a status of network connection with the cloud; and determine, in response to determining that the status of network connection is abnormal, that the preset information sending condition is not satisfied.

In some alternative implementations of the present embodiment, the resource includes a response text; and the command responding unit 505 may be further configured to: perform voice synthesis on the response text, to output the synthesized voice.

In some alternative implementations of the present embodiment, the resource includes a query result. The command responding unit 505 may be further configured to: display a page corresponding to the query result.

In some alternative implementations of the present embodiment, the apparatus 500 may further include a text generating unit that is not shown in FIG. 5, and is configured to: generate, in response to not satisfying the preset information sending condition, a response text for the voice command based on a historical response text.

In some alternative implementations of the present embodiment, the apparatus 500 may further include a command determining unit that is not shown in FIG. 5, and is configured to: determine whether the voice command is a human-computer interaction command. The voice recognizing unit 502 may be further configured to: perform, in response to determining that the voice command is a human-computer interaction command, the voice recognition on the voice command to determine the corresponding voice text.

In some alternative implementations of the present embodiment, the command determining unit may be further configured to: perform semantic analysis and intention recognition on the text information to determine a user intention; determine a probability of the text information belonging to a sentence; determine a text length corresponding to the text information; determine acoustic confidence of a syllable corresponding to acoustic information of the voice command and acoustic confidence of an entire sentence corresponding to the acoustic information; and determine whether the voice command belongs to a human-computer interaction command based on at least one of the user intention, the probability, the text length, the acoustic confidence of the syllable, or the acoustic confidence of the entire sentence.

In some alternative implementations of the present embodiment, the voice recognizing unit 502 may be further configured to: determine a definite text and an indefinite text in the voice command based on the acoustic confidence corresponding to the acoustic information and a preset confidence threshold; generate a prompt information based on the definite text and the indefinite text, and output the prompt information; receive a response voice for the prompt information; recognize a clarification text in the response voice; and determine a corresponding voice text based on the definite text and the clarification text.

In some alternative implementations of the present embodiment, the text sending unit 503 may be further configured to: send the recognized text to the cloud in the process of voice recognition of the voice command.

In some alternative implementations of the present embodiment, the text sending unit 503 may be further configured to: determine whether the recognized text satisfies a preset condition in the voice recognition process of the voice command; and send the recognized text to the cloud in response to determining that the recognized text satisfies the preset condition.

In some alternative implementations of the present embodiment, the command responding unit 505 may be further configured to: display, in response to receiving an intermediate resource sent from the cloud in the recognition process of the voice command, the intermediate resource.

It should be understood that the units 501 to 505 described in the apparatus 500 for a human-computer interaction correspond to the steps in the method described with reference to FIG. 2 respectively. Therefore, the operations and features described above for the method for a human-computer interaction also apply to the apparatus 500 and the units included therein.

The description will not be repeated here.

In the technical solutions of some embodiments of the present disclosure, the collection, storage, use, processing, transmission, provision, and disclosure of user personal information involved are in conformity with relevant laws and regulations, and do not violate public order and good customs.

According to an embodiment of the present disclosure, the present disclosure further provides an electronic device, a readable storage medium, and a computer program product.

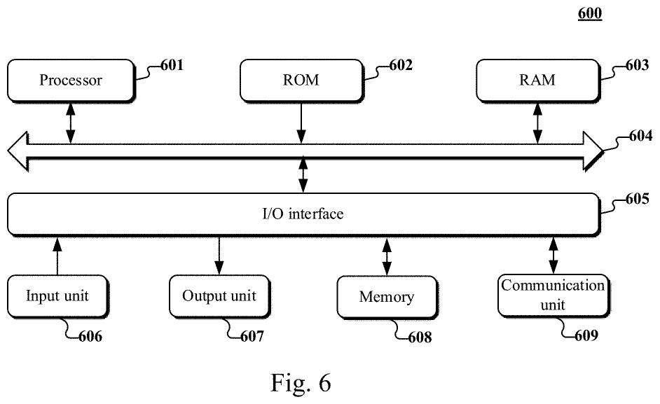

FIG. 6 shows a block diagram of an electronic device 600 that may be configured to implement the method for a human-computer interaction according to some embodiments of the present disclosure. The electronic device is intended to represent various forms of digital computers, such as a laptop computer, a desktop computer, a workbench, a personal digital assistant, a server, a blade server, a mainframe computer, and other suitable computers. The electronic device may alternatively represent various forms of mobile apparatuses, such as a personal digital assistant, a cellular phone, a smart phone, a wearable device, and other similar computing apparatuses. The components shown herein, the connections and relationships thereof, and the functions thereof are used as examples only, and are not intended to limit implementations of the present disclosure described and/or claimed herein.

As shown in FIG. 6, the electronic device 600 includes a processor 601, which may execute various appropriate actions and processes in accordance with a computer program stored in a read-only memory (ROM) 602 or a computer program loaded into a random access memory (RAM) 603 from a memory 608. The RAM 603 may further store various programs and data required by operations of the electronic device 600. The processor 601, the ROM 602, and the RAM 603 are connected to each other through a bus 604. An input/output (I/O) interface 605 is also connected to the bus 604.

A plurality of components in the electronic device 600 is connected to the I/O interface 605, including: an input unit 606, such as a keyboard and a mouse; an output unit 607, such as various types of displays and speakers; a memory 608, such as a magnetic disk and an optical disk; and a communication unit 609, such as a network card, a modem, and a wireless communication transceiver. The communication unit 609 allows the electronic device 600 to exchange information/data with other devices through a computer network such as the Internet and/or various telecommunication networks.

The processor 601 may be various general purpose and/or specific purpose processing components having a processing capability and a computing capability. Some examples of the processor 601 include, but are not limited to, a central processing unit (CPU), a graphics processing unit (GPU), various specific purpose artificial intelligence (AI) computing chips, various processors running a machine learning model algorithm, a digital signal processor (DSP), and any appropriate processor, controller, micro-controller, and the like. The processor 601 executes various methods and processes described above, such as the method for a human-computer interaction. For example, in some embodiments, the method for a human-computer interaction may be implemented as a computer software program that is tangibly included in a machine readable storage medium, such as the memory 608. In some embodiments, some or all of the computer programs may be loaded and/or installed onto the electronic device 600 via the ROM 602 and/or the communication unit 609. When the computer program is loaded into the RAM 603 and executed by the processor 601, one or more steps of the method for a human-computer interaction described above may be executed. Alternatively, in other embodiments, the processor 601 may be configured to execute the method for a human-computer interaction by any other appropriate approach (e.g., by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), computer hardware, firmware, software, and/or a combination thereof. The various implementations may include: being implemented in one or more computer programs, where the one or more computer programs may be executed and/or interpreted on a programmable system including at least one programmable processor, and the programmable processor may be a specific-purpose or general-purpose programmable processor, which may receive data and instructions from a storage system, at least one input apparatus and at least one output apparatus, and send the data and instructions to the storage system, the at least one input apparatus and the at least one output apparatus.

Program codes for implementing the method of the present disclosure may be compiled using any combination of one or more programming languages. The above program codes may be packaged into a computer program product. The program codes or the computer program product may be provided to a processor or controller of a general purpose computer, a specific purpose computer, or other programmable apparatuses for data processing, such that the program codes, when executed by the processor 601, cause the functions/operations specified in the flowcharts and/or block diagrams to be implemented. The program codes may be completely executed on a machine, partially executed on a machine, partially executed on a machine and partially executed on a remote machine as a separate software package, or completely executed on a remote machine or server.

In the context of the present disclosure, a machine readable storage medium may be a tangible medium which may contain or store a program for use by, or used in combination with, an instruction execution system, apparatus or device. The machine readable storage medium may be a machine readable signal storage medium or a machine readable storage medium. The computer readable storage medium may include, but is not limited to, electronic, magnetic, optical, electromagnetic, infrared, or semiconductor systems, apparatuses, or devices, or any appropriate combination of the above. A more specific example of the machine readable storage medium will include an electrical connection based on one or more pieces of wire, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any appropriate combination of the above.

To provide interaction with a user, the systems and technologies described herein may be implemented on a computer that is provided with: a display apparatus (e.g., a CRT (cathode ray tube) or an LCD (liquid crystal display) monitor) configured to display information to the user; and a keyboard and a pointing apparatus (e.g., a mouse or a trackball) by which the user can provide an input to the computer. Other kinds of apparatuses may also be configured to provide interaction with the user. For example, feedback provided to the user may be any form of sensory feedback (e.g., visual feedback, auditory feedback, or tactile feedback); and an input may be received from the user in any form (including an acoustic input, a voice input, or a tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and generally interact with each other through a communication network. The relationship between the client and the server is generated by virtue of computer programs that run on corresponding computers and have a client-server relationship with each other. The server may be a cloud server, which is also known as a cloud computing server or a cloud host and is a host product in a cloud computing service system to solve the defects of difficult management and weak service extendibility existing in conventional physical hosts and virtual private servers (VPS). The server may also be a server of a distributed system, or a server combined with a blockchain.

It should be understood that the various forms of processes shown above may be used to reorder, add, or delete steps. For example, the steps disclosed in some embodiments of the present disclosure may be executed in parallel, sequentially, or in different orders, as long as the desired results of the technical solutions mentioned in some embodiments of the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for a human-computer interaction, comprising:
acquiring a voice command;
performing voice recognition on the voice command to determine a corresponding voice text;
sending, in response to satisfying a preset information sending condition, the corresponding voice text to a cloud;
receiving a resource for the voice command returned from the cloud; and
responding to the voice command based on the resource.

2. The method according to claim 1, wherein the method further comprises:
performing intention recognition on the voice text to determine a user intention; and
determining, in response to determining that the user intention instructs to control a client, that the preset information sending condition is not satisfied.

3. The method according to claim 1, wherein the method further comprises:
determining a status of network connection with the cloud; and
determining, in response to determining that the status of network connection is abnormal, that the preset information sending condition is not satisfied.

4. The method according to claim 1, wherein the resource comprises a response text; and
the responding to the voice command based on the resource comprises
performing voice synthesis on the response text, to output a synthesized voice.

5. The method according to claim 1, wherein the resource comprises a query result; and
the responding to the voice command based on the resource comprises displaying a page corresponding to the query result.

6. The method according to claim 4, wherein the method further comprises:
generating, in response to not satisfying the preset information sending condition, a response text for the voice command based on a historical response text.

7. The method according to claim 1, wherein the performing the voice recognition on the voice command to determine the corresponding voice text comprises:
determining whether the voice command is a human-computer interaction command; and
performing, in response to determining that the voice command is the human-computer interaction command, the voice recognition on the voice command to determine the corresponding voice text.

8. The method according to claim 7, wherein the determining whether the voice command is the human-computer interaction command comprises:
performing semantic analysis and intention recognition on text information of the voice command to determine a user intention; and
determining a probability of the text information belonging to a sentence;
determining a text length corresponding to the text information;
determining:
(a) acoustic confidence of a syllable corresponding to acoustic information of the voice command and
(b) acoustic confidence of an entire sentence corresponding to the acoustic information; and
determining whether the voice command belongs to the human-computer interaction command based on at least one of
(i) the user intention, (ii) the probability, (iii) the text length, (iv) the acoustic confidence of the syllable, and (v) the acoustic confidence of the entire sentence.

9. The method according to claim 8, wherein the performing the voice recognition on the voice command to determine the corresponding voice text comprises:
determining a definite text and an indefinite text in the voice command based on the acoustic confidence corresponding to the acoustic information and a preset confidence threshold;
generating a prompt information based on the definite text and the indefinite text, and outputting the prompt information;
receiving a response voice for the prompt information;
recognizing a clarification text in the response voice; and
determining the corresponding voice text based on the definite text and the clarification text.

10. The method according to claim 1, wherein the sending, in response to satisfying the preset information sending condition, the voice text to the cloud comprises:
sending a recognized text to the cloud in a voice recognition process of the voice command.

11. The method according to claim 10, wherein the sending the recognized text to the cloud in the voice recognition process of the voice command comprises:
determining whether the recognized text satisfies a preset condition in the voice recognition process of the voice command; and
sending, in response to determining that the recognized text satisfies the preset condition, the recognized text to the cloud.

12. The method according to claim 10, wherein the method further comprises:
displaying, in response to receiving an intermediate resource sent from the cloud in the recognition process of the voice command, the intermediate resource.

13. An electronic device, comprising:
at least one processor; and
a memory communicatively connected to the at least one processor; wherein
the memory stores instructions executable by the at least one processor, and the instructions, when executed by the at least one processor, cause the at least one processor to perform operations comprising:
acquiring a voice command;
performing voice recognition on the voice command to determine a corresponding voice text;
sending, in response to satisfying a preset information sending condition, the corresponding voice text to a cloud;
receiving a resource for the voice command returned from the cloud; and
responding to the voice command based on the resource.

14. The electronic device according to claim 13, wherein the operations further comprise:
performing intention recognition on the voice text to determine a user intention; and
determining, in response to determining that the user intention instructs to control a client, that the preset information sending condition is not satisfied.

15. The electronic device according to claim 13, wherein the operations further comprise:
determining a status of network connection with the cloud; and
determining, in response to determining that the status of network connection is abnormal, that the preset information sending condition is not satisfied.

16. The electronic device according to claim 13, wherein the resource comprises a response text; and
the responding to the voice command based on the resource comprises:
performing voice synthesis on the response text, to output a synthesized voice.

17. The electronic device according to claim 13, wherein the resource comprises a query result; and
the responding to the voice command based on the resource comprises:
displaying a page corresponding to the query result.

18. The electronic device according to claim 16, wherein the operations further comprise:
generating, in response to not satisfying the preset information sending condition, a response text for the voice command based on a historical response text.

19. The electronic device according to claim 13, wherein the performing the voice recognition on the voice command to determine the corresponding voice text comprises:
determining whether the voice command is a human-computer interaction command; and
performing, in response to determining that the voice command is the human-computer interaction command, the voice recognition on the voice command to determine the corresponding voice text.

20. A non-transitory computer readable storage medium storing computer instructions, wherein the computer instructions cause a computer to perform operations comprising:
acquiring a voice command;
performing voice recognition on the voice command to determine a corresponding voice text;
sending, in response to satisfying a preset information sending condition, the corresponding voice text to a cloud;
receiving a resource for the voice command returned from the cloud; and
responding to the voice command based on the resource.
